(19) United States
(12) Patent Application Publication
(10) Pub. No.: US 2025/0054157 A1
(43) Pub. Date: Feb. 13, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Hiroshi FUKUI, Tokyo (JP)

(73) Assignee: NEC Corporation, Minato-ku, Tokyo (JP)

(21) Appl. No.: 18/722,729

(22) PCT Filed: Dec. 24, 2021
(86) PCT No.: PCT/JP2021/048286

§ 371 Date: Jun. 21, 2024

(51) Int. Cl. G06T 7/11; G06F 17/15; G06T 3/4046

(52) U.S. Cl. CPC G06T 7/11; G06F 17/15; G06T 3/4046; G06T 2207/20021; G06T 2207/20084

(57) ABSTRACT

An information processing apparatus includes: a generation unit that generates a patch token and a prefix token corresponding to an input image; an extension unit that extends the prefix token to a prefix token block having a size corresponding to a number of a plurality of patch token blocks into which the patch token is segmented in accordance with a predetermined grid pattern; and an arithmetic unit that performs an arithmetic operation on the prefix token block and the patch token blocks, on the basis of a self-attention mechanism, for each group of elements located at a common position in the respective blocks. According to the information processing apparatus, it is possible to properly perform processing based on the self-attention mechanism on the input image.

### TECHNICAL FIELD

This disclosure relates to technical fields of an information processing apparatus, an information processing method, and a recording medium.

### BACKGROUND ART

A known apparatus of this type divides an image into grids to perform various types of processing. For example, Patent Literature 1 discloses that a quantized gradient directional feature quantity is obtained from a luminance gradient in each of grids into which an image is divided. Patent Literature 2 discloses dividing an image into N×N grids to extract a D-dimensional feature vector from each cell in the grid.

In addition, there is known an apparatus that processes an image and that uses a self-attention/self-caution mechanism. For example, Patent Literature 3 discloses that a layer of an apparatus that recognizes an image has a self-attention structure. Patent Literature 4 discloses that a feature quantity vector related to an image is corrected by using a query, a key, and a value.

### CITATION LIST

### Patent Literature

Patent Literature 1: JP2017-201498A
Patent Literature 2: JP2017-091525A
Patent Literature 3: JP2021-093144A
Patent Literature 4: International Publication No. WO2021/095212A1

### SUMMARY

### Technical Problem

This disclosure aims to improve the techniques/technologies disclosed in Citation List.

### Solution to Problem

An information processing apparatus according to an example aspect of this disclosure includes: a generation unit that generates a patch token and a prefix token corresponding to an input image; an extension unit that extends the prefix token to a prefix token block having a size corresponding to a number of a plurality of patch token blocks into which the patch token is segmented in accordance with a predetermined grid pattern; and an arithmetic unit that performs an arithmetic operation on the prefix token block and the patch token blocks, on the basis of a self-attention mechanism, for each group of elements located at a common position in the respective blocks.

An information processing method according to an example aspect of this disclosure includes: generating a patch token and a prefix token corresponding to an input image; extending the prefix token to a prefix token block having a size corresponding to a number of a plurality of patch token blocks into which the patch token is segmented in accordance with a predetermined grid pattern; and performing an arithmetic operation on the prefix token block and the patch token blocks, on the basis of a self-attention mechanism, for each group of elements located at a common position in the respective blocks.

A recording medium according to an example aspect of this disclosure is a recording medium on which a computer program that allows at least one computer to execute an information processing method is recorded, the information processing method including: generating a patch token and a prefix token corresponding to an input image; extending the prefix token to a prefix token block having a size corresponding to a number of a plurality of patch token blocks into which the patch token is segmented in accordance with a predetermined grid pattern; and performing an arithmetic operation on the prefix token block and the patch token blocks, on the basis of a self-attention mechanism, for each group of elements located at a common position in the respective blocks.

### BRIEF DESCRIPTION OF DRAWINGS

FIG. 1 is a block diagram illustrating a hardware configuration of an information processing apparatus according to a first example embodiment.

FIG. 2 is a block diagram illustrating an overall configuration of the information processing apparatus according to the first example embodiment.

FIG. 3 is a block diagram illustrating a configuration of a self-attention mechanical unit in the information processing apparatus according to the first example embodiment.

FIG. 4 is a block diagram illustrating a functional configuration of the information processing apparatus according to the first example embodiment.

FIG. 5 is a flowchart illustrating a flow of feature embedding processing in the information processing apparatus according to the first example embodiment.

FIG. 6 is a conceptual diagram illustrating an example of extension processing of extending a prefix token and modification processing of modifying a patch token in the information processing apparatus according to the first example embodiment.

FIG. 7 is a conceptual diagram illustrating an example of processing based on a self-attention mechanism for each group of elements in the information processing apparatus according to the first example embodiment.

FIG. 8 is a block diagram illustrating a functional configuration of an information processing apparatus according to a second example embodiment.

FIG. 9 is a flowchart illustrating a flow of feature transformation processing in the information processing apparatus according to the second example embodiment.

FIG. 10 is a conceptual diagram illustrating an example of restoration processing in the information processing apparatus according to the second example embodiment;

FIG. 11 is a conceptual diagram illustrating an example of restoration processing using a mean value in an information processing apparatus according to a third example embodiment.

FIG. 12 is a conceptual diagram illustrating an example of restoration processing using a maximum value in an information processing apparatus according to a fourth example embodiment.

FIG. 13 is a block diagram illustrating a functional configuration of an information processing apparatus according to a fifth example embodiment.

FIG. 14 is a flowchart illustrating a flow of feature embedding processing in the information processing apparatus according to the fifth example embodiment.

FIG. 15 is a conceptual diagram illustrating in-block modification processing of modifying a patch token in the information processing apparatus according to the fifth example embodiment.

FIG. 16 is a block diagram illustrating a functional configuration of an information processing apparatus according to a sixth example embodiment.

FIG. 17 is a flowchart illustrating a flow of feature transformation processing in the information processing apparatus according to the sixth example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

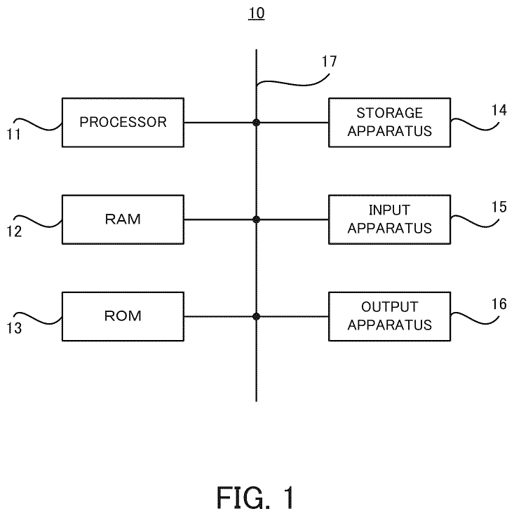

An information processing apparatus according to a first example embodiment will be described with reference to FIG. 1 to FIG. 7.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for performing processing based on a self-attention mechanism using an image as an input, is realized or implemented in the processor 11. That is, the processor 11 may function as a controller for executing each control of the information processing apparatus 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM12 may be, for example, a D-RAM (Dynamic Random Access Memory) or a SRAM (Static Random Access Memory). Furthermore, another type of volatile memory may also be used instead of the RAM12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM13.

The storage apparatus 14 stores the data that are stored for a long term by the information processing apparatus 10. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing apparatus 10.

Of the hardware described in FIG. 1, a part of the hardware may be provided in an apparatus other than the information processing apparatus 10. For example, the information processing apparatus 10 may include only the processor 11, the RAM 12, and the ROM13, and the other components (i.e., the storage apparatus 14, the input apparatus 15, and the output apparatus 16) may be provided in an external apparatus connected to the information processing apparatus 10, for example. Furthermore, in the information processing apparatus 10, a part of an arithmetic function may also be realized by an external apparatus (e.g., an external server or cloud, etc.).

### (Overall Configuration)

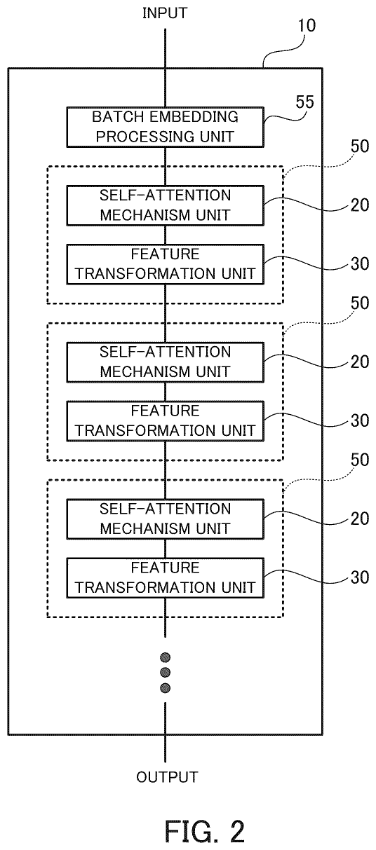

Next, an overall configuration of the information processing apparatus 10 according to the first example embodiment will be described with reference to FIG. 2. FIG. 2 is a block diagram illustrating the overall configuration of the information processing apparatus according to the first example embodiment.

As illustrated in FIG. 2, the information processing apparatus 10 according to the first example embodiment may include a batch embedding processing unit 55 and a plurality of transformation blocks 50. Each of the plurality of transformation blocks 50 may include a self-attention mechanism unit 20 and a feature transformation unit 30. The information processing apparatus 10 may be configured as a neural network that is networked by the plurality of transformation blocks 50, for example. The feature transformation unit 30 according to the first example embodiment is configured to output some feature quantity related to an image by using the image as an input.

The batch embedding processing 55 is configured to perform batch embedding processing on an input. The batch embedding processing here may be processing of compressing a local area of an input image based on a convolutional layer, into a feature vector as a token.

The self-attention mechanism unit 20 is configured to generate a new feature quantity, by dividing an inputted feature quantity into three feature quantities of a query, a key, and a value, and performing predetermined calculation processing. A specific configuration and operation of the self-attention mechanism unit 20 will be described in detail later.

The feature transformation unit 30 is configured to extract a feature quantity (feature map) from the inputted image. The feature transformation unit 30 may be configured as a unit that performs feature extraction by using a convolutional layer with a local kernel, for example. Since a specific method of extracting the feature quantity by the feature transformation unit 30 can employ the existing techniques/technologies as appropriate, a detailed description thereof will be omitted.

### (Self-Attention Mechanism Unit)

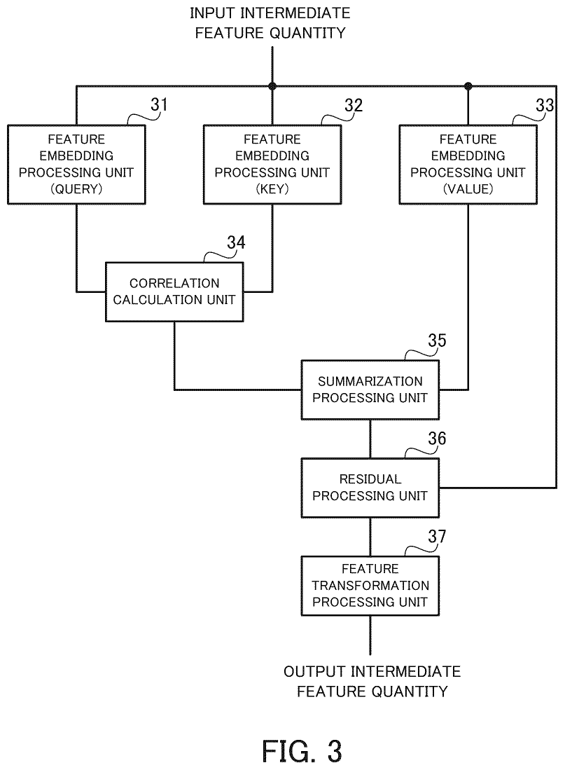

Next, with reference to FIG. 3, a configuration and operation of the self-attention mechanism unit 20 will be described. FIG. 3 is a block diagram illustrating the configuration of the self-attention mechanism unit in the information processing apparatus according to the first example embodiment.

As illustrated in FIG. 3, the self-attention mechanism unit 20 includes three feature embedding processing units 31, 32, and 33, a correlation calculation unit 34, a summarization processing unit 35, a residual processing unit 36, and a feature transformation processing unit 37.

The feature embedding processing unit 31 is configured to extract a “query” from an inputted feature map. The feature embedding processing unit 32 is configured to extract a “key” from the inputted feature map. The feature embedding processing unit 33 is configured to extract a “value” from the inputted feature map. Each of the feature embedding processing units 31, 32, and 33 may extract the feature quantity by using a convolutional layer or a fully coupled layer used in a convolutional neural network, for example. The query generated by the feature embedding processing unit 31 and the key generated by the feature embedding processing unit 32 are configured to be outputted to the correlation calculation unit 34. The value generated by the feature embedding processing unit 33 is configured to be outputted to the summarization processing unit 35.

The correlation calculation unit 34 is configured to calculate a feature map indicating a correlation between the query generated by the feature embedding processing unit 31 and the key generated by the feature embedding processing unit 32. Especially in the present example embodiment, it is possible to refer to an entire space of an inputted feature map by using a predetermined grid pattern. This grid pattern will be described in detail later. The correlation calculation unit 34 may obtain the correlation by performing shape transformation of a tensor and then calculating a matrix product, for example. In addition, the correlation calculation unit 34 may obtain the correlation by performing the shape transformation of the tensor on embedded features of the query and the key and then combining the two embedded features. The correlation calculation unit 34 may perform convolution and calculation of a normalized linear function (ReLU: Rectified Linear Unit) on the matrix product or the combined features calculated as described above, thereby to acquire the feature map illustrating a final correlation. The correlation calculation unit 34 may further include a convolutional layer for convolution. The correlation calculation unit 34 may normalize the feature map indicating the correlation, by using a sigmoid function, a soft max function, or the like. The feature map indicating the correlation calculated by the correlation calculation unit 34 is configured to be outputted to the summarization processing unit 35.

The summarization processing unit 35 is configured to reflect the feature map indicating the correlation calculated by the correlation calculation unit 34, as a weight, in the value generated by the feature embedding processing unit 33. Such processing may be performed, for example, by calculating the feature map of the correlations (weight) and the value, in the matrix product. The feature map reflecting the correlation is configured to be outputted to the residual processing unit 36.

The residual processing unit 36 is configured to perform residual processing on the feature map generated by the summarization processing unit 35. The residual processing may be processing of adding the feature map generated by the summarization processing unit 35 and the feature map inputted to the self-attention mechanism unit 20. This is to prevent that the feature map as a result of an arithmetic operation of the self-attention mechanism unit 20 is not generated, even if the correlation is not calculated. For example, when 0 is calculated as the correlation (weight), the value is multiplied by the 0, by which the feature value is 0 (disappears) in the feature map outputted by the summarization processing unit 35. To prevent this, the residual processing unit 36 performs the residual processing. The feature map generated by the residual processing unit 36 is configured to be outputted to the feature transformation processing unit 37.

The feature transformation processing unit 37 is configured to perform processing of transforming the feature map generated by the residual processing unit 36 into an appropriate state (hereinafter referred to as “feature transformation processing” as appropriate). Specific processing content of the feature transformation processing will be described in detail in another example embodiment later.

### (Functional Configuration)

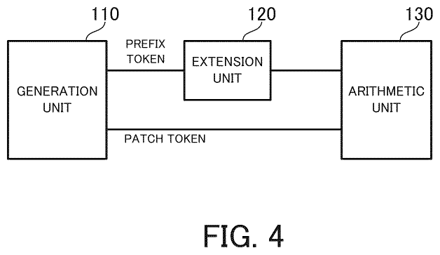

Next, with reference to FIG. 4, a functional configuration of the information processing apparatus 10 according to the first example embodiment (especially, a configuration for realizing the functions of the feature embedding processing units 31, 32, and 33) will be described. FIG. 4 is a block diagram illustrating the functional configuration of the information processing apparatus according to the first example embodiment.

As illustrated in FIG. 4, the information processing apparatus 10 according to the first example embodiment includes, as components for realizing the functions thereof, a generation unit 110, an extension unit 120, and an arithmetic unit 130. Each of the generation unit 110, the extension unit 120, and the arithmetic unit may be a processing block realized or implemented by the processor 11 (see FIG. 1), for example.

The generation unit 110 is configured to generate a patch token and a prefix token corresponding to an inputted image. The prefix token is an attribute token for assisting in understanding a structure of an input token, and has other attributes such as a clause and an end of a sentence. The patch token is a token obtained by vectorizing pixels of a local area of an input image. The prefix token and the patch token may be token vectors handled in ViT (Vision Transformer). The prefix token may be generated on the basis of a random number. In this case, vector elements may be optimized by learning. The prefix token generated by the generation unit 110 is configured to be outputted to the expansion unit 120. On the other hand, the patch token is configured to be outputted to the arithmetic unit 130.

The extension unit 120 is configured to extend/expand a size of the prefix token generated by the generation unit 110. Specifically, the extension unit 120 is configured to extend the size of the prefix token to a size corresponding to the number of a plurality of patch token blocks included in the patch token. The patch token blocks are blocks into which the patch token is segmented (equally divided) in accordance with a predetermined grid pattern. The prefix token typically includes only one element, whereas the patch token block includes a plurality of elements. The extension unit 120 copies and pastes one element of the prefix token, thereby extend it to a prefix token block of the same size as the number of the patch token blocks, for example. The prefix token block extended by the extension unit 120 is configured to be outputted to the arithmetic unit 130.

The arithmetic unit 130 is configured to perform arithmetic processing based on the self-attention mechanism (i.e., various types of processing described in FIG. 3) on the prefix token block extended by the extension unit 120 and the patch token (the plurality of patch token blocks) acquired from the generation unit 120. The arithmetic unit 130 according to the present example embodiment is especially configured to perform the arithmetic processing based on the self-attention mechanism, on the prefix token block and the patch token blocks, for each group of elements located at a common position in the respective blocks. For example, elements located at the top left in the respective blocks are integrated as a group of elements, and the arithmetic processing based on the self-attention mechanism is performed thereon. Similarly, elements located at the top right in the respective blocks are integrated as a group of elements, and the arithmetic processing based on the self-attention mechanism is performed thereon. This processing will be described in detail with a specific example later.

### (Flow of Operation)

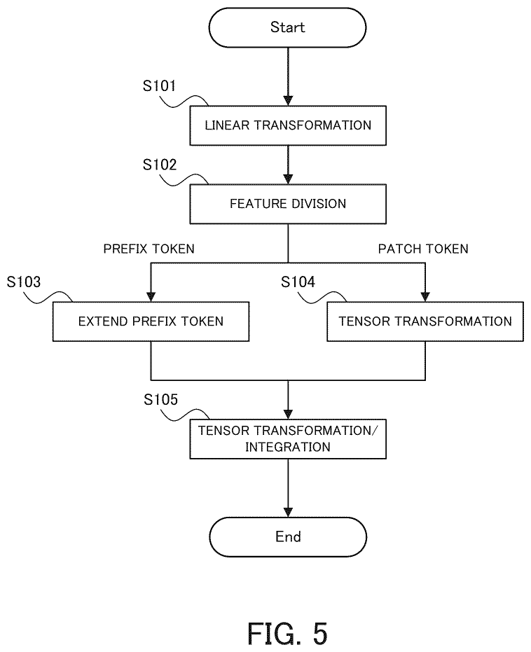

Next, with reference to FIG. 5, a flow of operation of the information processing apparatus according to the first example embodiment (especially, feature embedding processing by the feature embedding processing units 31, 32, and 33) will be described. FIG. 5 is a flowchart illustrating a flow of the feature embedding processing in the information processing apparatus according to the first example embodiment.

As illustrated in FIG. 5, when the feature embedding processing by the information processing apparatus 10 according to the first example embodiment (i.e., the processing by the feature embedding processing units 31, 32, and 33 illustrated in FIG. 3) is started, first, linear transformation processing is performed on the inputted feature quantity (step S101). The linear transformations may be processed in a convolutional layer or a fully coupled layer.

Subsequently, the generation unit 110 generates the patch token and the prefix token corresponding to the input image, and divides the patch token into a plurality of areas (step S102). The prefix token may be generated from the random number as described above. The extension unit 120 extends the size of the prefix token and forms the prefix token block (step S103). On the other hand, tensor transformation processing is performed on the patch token (step S104). The tensor transformation processing here is processing of transforming the elements located at a common position, into one tensor.

Subsequently, the arithmetic unit 130 performs the tensor transformation/integration on the prefix token block and the patch token on which the tensor transformation is performed (step S105). Specifically, the elements of the prefix token block and the patch token on which the tensor transformation is performed, are integrated and transformed into a one-dimensional tensor. Each tensor includes the elements located at a common position in the respective blocks.

### Specific Operation Example

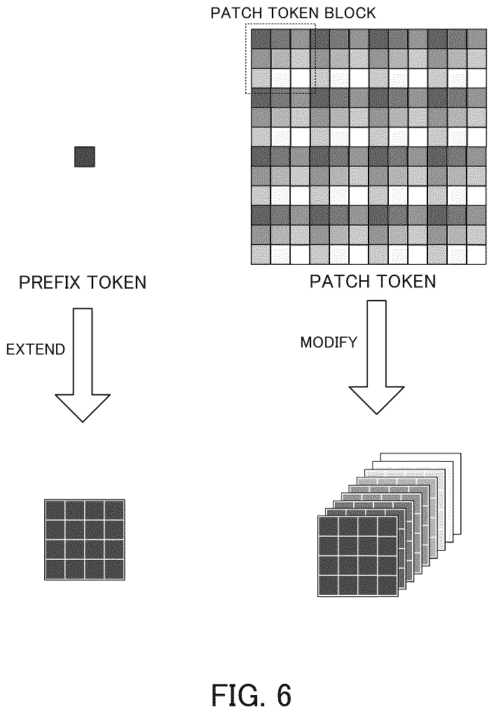

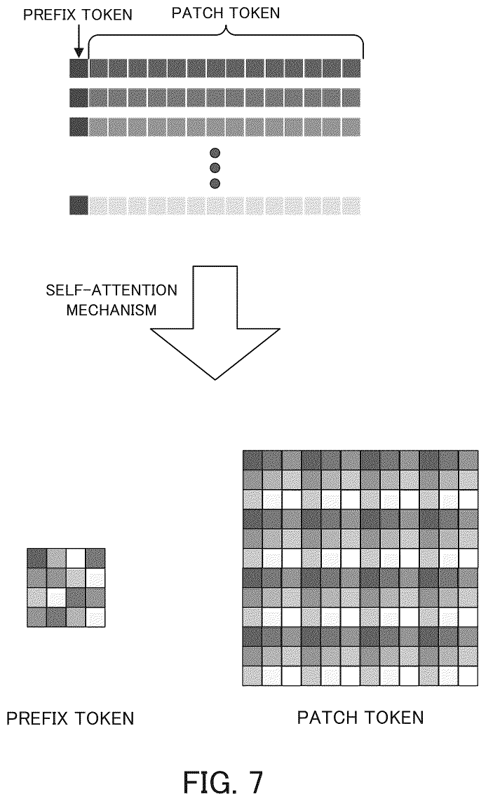

Next, a specific operation example of the information processing apparatus 10 (especially, an operation example of the generation unit 110, the extension unit 120, and the arithmetic unit 130) according to the first example embodiment will be described with reference to FIG. 6 and FIG. 7. FIG. 6 is a conceptual diagram illustrating an example of extension processing of extending the prefix token and modification processing of modifying the patch token in the information processing apparatus according to the first example embodiment. FIG. 7 is a conceptual diagram illustrating an example of the processing based on the self-attention mechanism for each group of elements in the information processing apparatus according to the first example embodiment.

As illustrated in FIG. 6, the generation unit 110 generates the patch token and the prefix token corresponding to the input image. The prefix token here includes only one element, and the patch token includes 12×12 elements. The elements of the patch token may correspond to the number of pixels of the image.

The patch token can be segmented into a plurality of patch token blocks by a predetermined grid pattern. The patch token block here includes 3×3 elements. Furthermore, in the example illustrated in the figure, for convenience of description, color (shading) is illustrated to be different depending on a position in the block.

The size of the prefix token is extended to the same size as the number of blocks in the patch token block (4×4 in this case). On the other hand, the tensor transformation is performed on the patch token, for each group of elements located at a common position in the blocks (i.e., elements indicated in the same color are grouped).

As illustrated in FIG. 7, the prefix token and the patch token are integrated as a one-dimensional vector. Specifically, a tensor is generated, with the prefix token at the head, followed by each element of the patch token. This tensor is a collection of elements located at a common position in the blocks. For this reason, the patch token included in each tensor is the elements indicated in the same color.

In the present example embodiment, the arithmetic processing based on the self-attention mechanism is performed for each tensor (i.e., each group of elements located at a common position in the blocks) described above. In the case of a general self-attention mechanism, computational complexity of the square of the number of elements to be inputted is required; however, by performing the arithmetic processing for each group of elements as in the present example embodiment, the computational complexity can be set as the number of elements×K2×C (K is a kernel size and C is a channel). As a result of the arithmetic operation by the self-attention mechanism, the feature map corresponding to the prefix token and the patch token is obtained.

### Technical Effect

Next, a technical effect obtained by the information processing apparatus 10 according to the first example embodiment will be described.

As described in FIG. 1 to FIG. 7, the information processing apparatus 10 according to the first example embodiment generates the patch token and the prefix token corresponding to the input image. Then, the arithmetic processing based on the self-attention mechanism is performed on the extended prefix token block and the plurality of patch token blocks included in the patch token, for each group of elements located at a common position in the blocks. In this way, it is possible to reduce the computational complexity in the self-attention mechanism. Such an effect is more pronounced in a case where the image is used as an input (i.e., in a case where there are many elements). Since there is a prefix token having only one element, it is hard to integrate it with the patch token as is (it is hard to integrate the respective blocks if they do not have the same size). In the present example embodiment, however, since the extension processing is performed on the prefix token, it is possible to perform appropriate integration and perform the arithmetic processing for each group of elements.

The information processing apparatus 10 according to the present example embodiment may be applied, for example, to a task handling a high-dimensional feature vector. For example, it may be applied to object detection, object tracking, semantic segmentation, or the like. It may also be used for image patterns recognition.

### Second Example Embodiment

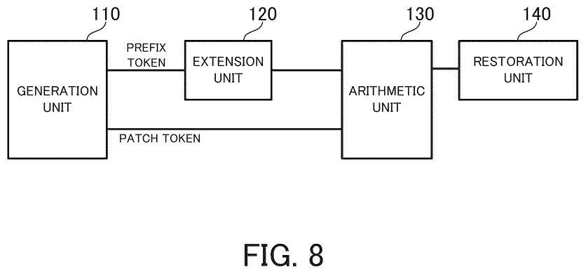

The information processing apparatus 10 according to a second example embodiment will be described with reference to FIG. 8 to FIG. 10. The second example embodiment is partially different from the first example embodiment only in the configuration, and may be the same as the first example embodiment in the other parts. For this reason, a part that is different from the first example embodiment will be described in detail below, and a description of the other overlapping parts will be omitted as appropriate.

### (Functional Configuration)

First, with reference to FIG. 8, a functional configuration of the information processing apparatus 10 according to the second example embodiment (especially, a configuration for realizing the functions of the feature embedding processing units 31, 32, and 33 and the feature transformation processing unit 37) will be described. FIG. 8 is a block diagram illustrating the functional configuration of the information processing apparatus according to the second example embodiment. In FIG. 8, the same components as those illustrated in FIG. 4 carry the same reference numerals.

As illustrated in FIG. 8, the information processing apparatus 10 according to the second example embodiment includes, as components for realizing the functions thereof, the generation unit 110, the extension unit 120, the arithmetic unit 130, and a restoration unit 140. That is, the information processing apparatus 10 according to the second example embodiment further includes the restoration unit 140, in addition to the configuration in the first example embodiment (see FIG. 4). The restoration unit 140 may be a processing block realized or implemented by the processor 11 (see FIG. 1), for example.

The restoration unit 140 is configured to restore a size of the feature quantity corresponding to the prefix token block, of the feature quantities obtained as the result of the arithmetic operation based on the self-attention mechanism, to the size of the prefix token before the extension. For example, the restoration unit 140 may be configured to perform downsizing by pooling processing.

### (Flow of Operation)

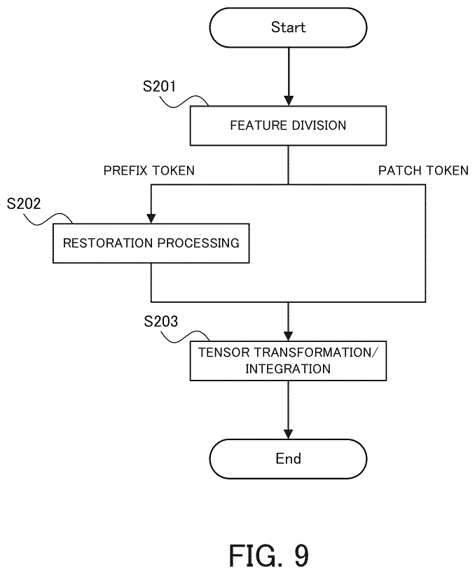

Next, with reference to FIG. 9, a flow of operation of the information processing apparatus according to the second example embodiment (especially, feature transformation processing by the feature transformation processing unit 37) will be described. FIG. 9 is a flowchart illustrating the flow of the feature transformation processing in the information processing apparatus according to the second example embodiment.

As illustrated in FIG. 9, when the feature transformation processing by the information processing apparatus 10 according to the first example embodiment is started, first, the generation unit 110 generates the patch token and the prefix token corresponding to the input image, and divides the patch token into a plurality of areas (step S201). This processing may be the same processing as the feature division in the feature embedding processing (i.e., the step S101 in FIG. 5)

The restoration unit 140 performs restoration processing on the divided prefix token, to restore a size thereof to the size before the extension by the extension unit 120 (step S202). The arithmetic unit 130 performs the tensor transformation/integration on the restored prefix token and the patch token (step S203). That is, the prefix token and the patch token are transformed into one feature map.

### Specific Operation Example

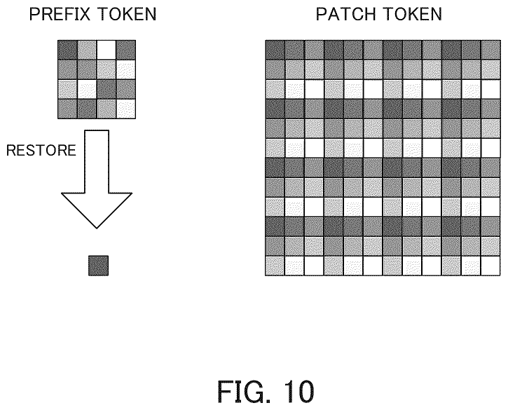

Next, a specific operation example of the information processing apparatus 10 (especially, an operation example of the restoration unit 140) according to the second example embodiment will be described with reference to FIG. 10. FIG. 10 is a conceptual diagram illustrating an example of the restoration processing in the information processing apparatus according to the second example embodiment.

As illustrated in FIG. 10, the feature quantity corresponding to the prefix token obtained as the result of the arithmetic operation based on the self-attention mechanism has the size extended by the extension unit 120 (4×4 in this case). The restoration unit 140 performs the restoration processing on this, and transforms the size to the size before the extension (1×1 in this case). A specific method of the restoration processing is not particularly limited. A specific example of the restoration processing will be described in detail in another example embodiment later.

### Technical Effect

Next, a technical effect obtained by the information processing apparatus 10 according to the second example embodiment will be described.

As described in FIG. 8 to FIG. 10, in the information processing apparatus 10 according to the second example of example embodiment, the size of the prefix token obtained as the result of the arithmetic operation based on the self-attention mechanism (i.e., the extended size of the prefix token) is restored to the size before the extension. In this way, it is possible to restore the size of the prefix token temporarily changed for the arithmetic operation based on the self-attention mechanism. That is, the size may be restored to an appropriate size as the prefix token.

### Third Example Embodiment

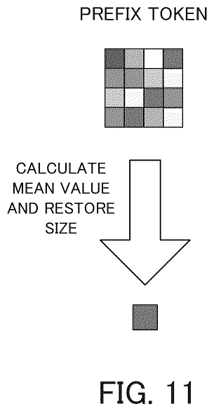

The information processing apparatus 10 according to a third example embodiment will be described with reference to FIG. 11. The third example embodiment describes a more specific example of the second example embodiment, and may be the same as the first and second example embodiments in the apparatus configuration and overall operation. For this reason, a part that is different from each of the example embodiments described above will be described in detail below, and a description of the other overlapping parts will be omitted as appropriate.

### Specific Example of Restoration Processing

First, with reference to FIG. 11, the restoration processing in the information processing apparatus 10 according to the third example embodiment will be described. FIG. 11 is a conceptual diagram illustrating an example of the restoration processing using a mean value in the information processing apparatus according to the third example embodiment.

As illustrated in FIG. 11, in the information processing apparatus 10 according to the third example embodiment, the restoration unit 140 performs the restoration processing by calculating a mean value/average value of the feature quantity corresponding to the prefix token. More specifically, the restoration unit 140 calculates the mean value of elements included in the feature quantity corresponding to the prefix token, and generates the prefix token including one element having the mean value.

### Technical Effect

Next, a technical effect obtained by the information processing apparatus 10 according to the third example embodiment will be described.

As described in FIG. 11, in the information processing apparatus 10 according to the third example embodiment, the restoration processing is performed by using the mean value. In this way, since it is possible to obtain the integrated token in view of all the patch tokens, it is possible to perform the restoration processing of restoring the prefix token, easily and accurately.

### Fourth Example Embodiment

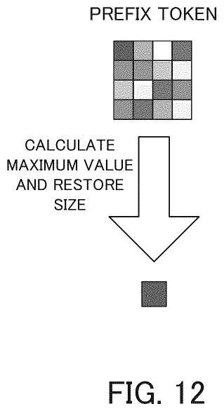

The information processing apparatus 10 according to a fourth example embodiment will be described with reference to FIG. 12. The fourth example embodiment describes a more specific example of the second example embodiment as in the third example embodiment, and may be the same as the first and second example embodiments in the apparatus configuration and overall operation. For this reason, a part that is different from each of the example embodiments described above will be described in detail below, and a description of the other overlapping parts will be omitted as appropriate.

### Specific Example of Restoration Processing

First, the restoration processing in the information processing apparatus 10 according to the fourth example embodiment will be described with reference to FIG. 12. FIG. 12 is a conceptual diagram illustrating an example of the restoration processing using a maximum value in the information processing apparatus according to the fourth example embodiment.

As illustrated in FIG. 12, in the information processing apparatus 10 according to the fourth example embodiment, the restoration unit 140 performs the restoration processing by calculating a maximum value of the feature quantity corresponding to the prefix token. More specifically, the restoration unit 140 calculates the maximum value of elements included in the feature quantity corresponding to the prefix token, and generates the prefix token including one element having the maximum value.

### Technical Effect

Next, a technical effect obtained by the information processing apparatus 10 according to the fourth example embodiment will be described.

As described in FIG. 12, in the information processing apparatus 10 according to the fourth example embodiment, the restoration processing is performed by using the maximum value. In this way, since it is possible to select a typical patch token by using the maximum value and obtain a final prefix token, it is possible to perform the restoration processing of restoring the prefix token, easily and accurately.

### Fifth Example Embodiment

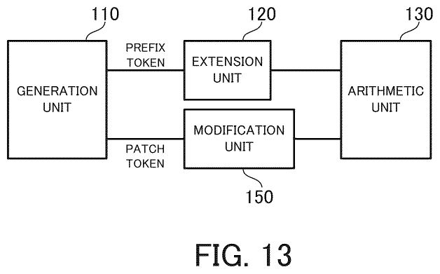

The information processing apparatus 10 according to a fifth example embodiment will be described with reference to FIG. 13 to FIG. 15. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of the other overlapping parts will be omitted as appropriate.

### (Functional Configuration)

First, with reference to FIG. 13, a functional configuration of the information processing apparatus 10 according to the fifth example embodiment (especially, a configuration for realizing the functions of the feature embedding processing units 31, 32, and 33) will be described. FIG. 13 is a block diagram illustrating the functional configuration of the information processing apparatus according to the fifth example embodiment. In FIG. 13, the same components as those illustrated in FIG. 4 carry the same reference numerals.

As illustrated in FIG. 13, the information processing apparatus 10 according to the fifth example embodiment includes, as components for realizing the functions thereof, the generation unit 110, the extension unit 120, the arithmetic unit 130, and a modification unit 150. That is, the information processing apparatus 10 according to the fifth example embodiment further includes the modification unit 150, in addition to the configuration in the first example embodiment (see FIG. 4). The modification unit 150 may be a processing block realized or implemented by the processor 11 (see FIG. 1), for example.

The modification unit 150 is configured to performing processing of modifying the tensor of the patch token. More specifically, the modification unit 150 is configured to perform the processing of modifying the tensors to provide a 1×1 convolutional layer (fully coupled layer) in each patch token block. This processing is performed to refer to elements in a local area in the feature map. That is, this processing is performed to suppress/reduce an influence of a situation where the elements are referred to in sparse patterns because the arithmetic processing is performed for each group of elements corresponding to the position in the blocks. In the following, the processing performed by the modification unit 150 is referred to as “in-block modification processing” as appropriate.

### (Flow of Operation)

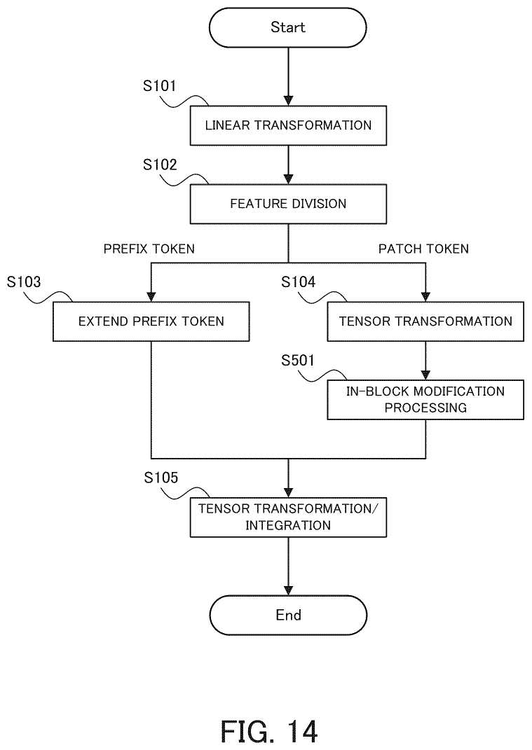

Next, with reference to FIG. 14, a flow of operation of the information processing apparatus 10 (especially, feature embedding processing by the feature embedding processing units 31, 32, and 33) according to the fifth example embodiment will be described. FIG. 14 is a flowchart illustrating the flow of the feature embedding processing in the information processing apparatus according to the fifth example embodiment. In FIG. 14, the same steps as those illustrated in FIG. 5 carry the same reference numerals.

As illustrated in FIG. 14, when the feature embedding processing by the information processing apparatus 10 according to the fifth example embodiment is started, first, the linear transformation processing is performed on the inputted feature quantity (step S101). Subsequently, the generation unit 110 generates the patch token and the prefix token corresponding to the input image, and divides the patch token into a plurality of areas (step S102).

The extension unit 120 extends the size of the prefix token and forms the prefix token block (step S103). On the other hand, the tensor transformation processing is performed on the patch token (step S104). In the present example embodiment, furthermore, the modification unit 140 performs the in-block modification processing (step S501).

Thereafter, the arithmetic unit 130 performs the tensor transformation/integration on the prefix token block and the patch token on which the in-block modification processing is performed (step S105).

The in-block modification processing may be performed on at least one of the query, the key, and the value. For example, the in-block modification processing may be performed on only one of the query, the key, and the value. Alternatively, the in-block modification processing may be performed on two of the query, the key, and the value. Alternatively, the in-block modification processing may be performed on all three of the query, the key, and the value.

### Specific Operation Example

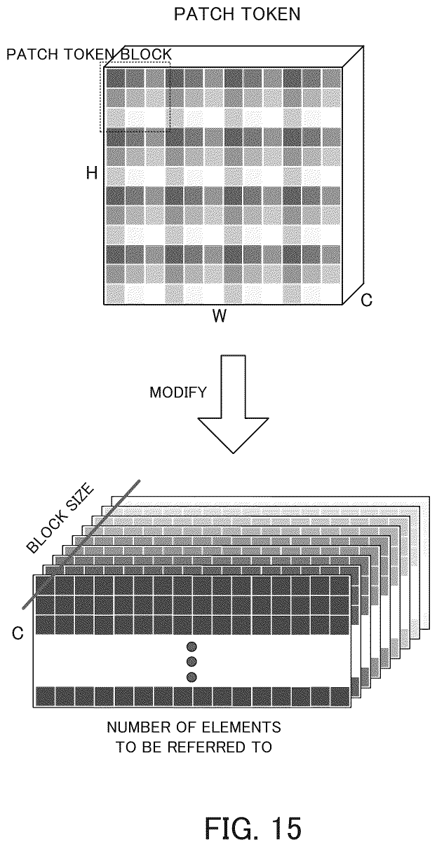

Next, with reference to FIG. 15, a specific operation example (especially, an operation example of the in-block modification processing) of the information processing apparatus 10 according to the fifth example embodiment will be described. FIG. 15 is a conceptual diagram illustrating the in-block modification processing of modifying the patch token in the information processing apparatus according to the fifth example embodiment.

As illustrated in FIG. 15, suppose that a patch token of the H×W×C is modified. In this case, in the in-block modification processing, the tensor transformation is performed to group the elements located at a common position in the locks (i.e., the elements indicated in the same color). As a result, a vertical direction of the figure is the number of channels (C), and a horizontal direction is the number of elements to be referred to (16 in this case). Then, a depth direction is a block size (here 3×3).

Here, in an upper left part after the modification, elements included in one patch token block (in other words, elements in a local area) are arranged. As described above, performing the in-block modification processing makes it possible to provide a 1×1 convolutional layers (fully coupled layer) in an area of the block.

### Technical Effect

Next, a technical effect obtained by the information processing apparatus 10 according to the fifth example embodiment will be described.

As described in FIG. 13 to FIG. 15, in the information processing apparatus 10 according to the fifth example embodiment, in the feature embedding processing, the patch token is modified to provide a 1×1 convolutional layer (fully coupled layer) in the area of the block. In this way, it is possible to eliminate a lack of information about the local area caused by the division using the grid pattern. Therefore, for example, it is possible to suppress/prevent a reduction in processing accuracy caused by the lack of information about the local area.

### Sixth Example Embodiment

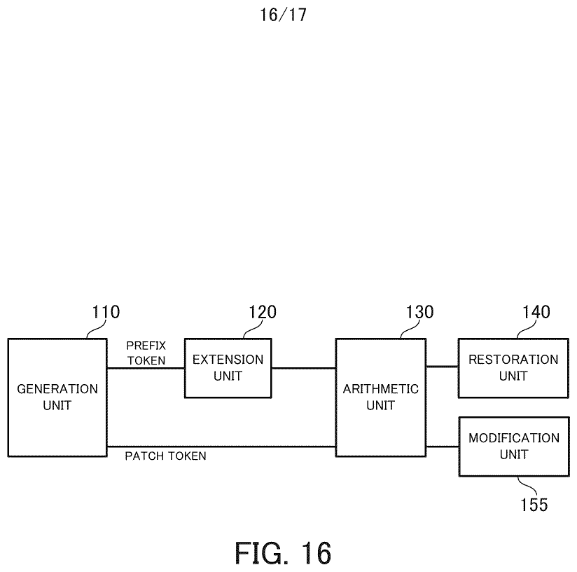

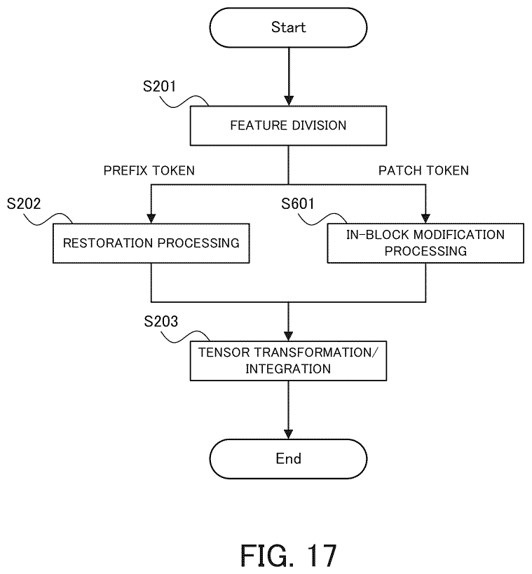

The information processing apparatus 10 according to a sixth example embodiment will be described with reference to FIG. 16 and FIG. 17. The sixth example embodiment is partially different from the fifth example embodiment only in the configuration and operation, and may be the same as the first to fifth example embodiments in the other parts. For this reason, a part that is different from each of the example embodiments described above will be described in detail below, and a description of the other overlapping parts will be omitted as appropriate.

### (Functional Configuration)

First, with reference to FIG. 16, a functional configuration of the information processing apparatus 10 according to the sixth example embodiment (especially, a configuration for realizing the functions of the feature embedding processing units 31, 32, and 33, and the feature transformation processing unit 37) will be described. FIG. 16 is a block diagram illustrating the functional configuration of the information processing apparatus according to the sixth example embodiment. In FIG. 16, the same components as those illustrated in FIG. 8 carry he same reference numerals.

As illustrated in FIG. 16, the information processing apparatus 10 according to the sixth example embodiment includes, as components for realizing the functions thereof, the generation unit 110, the extension unit 120, the arithmetic unit 130, the restoration unit 140, and a modification unit 155. That is, the information processing apparatus 10 according to the sixth example embodiment further includes the modification unit 155, in addition to the configuration in the second example embodiment (see FIG. 8). The modification unit 155 according to the sixth example embodiment may have the same function as that of the modification unit 150 according to the fifth example embodiment, and may be a processing block realized or implemented by the processor 11 (see FIG. 1), for example.

### (Flow of Operation)

Next, with reference to FIG. 17, a flow of operation of the information processing apparatus 10 according to the sixth example embodiment (especially, feature transformation processing by the feature transformation processing unit 37) will be described. FIG. 17 is a flowchart illustrating the flow of the feature transformation processing in the information processing apparatus according to the sixth example embodiment. In FIG. 17, the same steps as those illustrated in FIG. 9 carry the same reference numerals.

As illustrated in FIG. 17, when the feature transformation processing by the information processing apparatus 10 according to the sixth example embodiment is started, first, the generation unit 110 generates the patch token and the prefix token corresponding to the input image, and divides the patch token into a plurality of areas (step S201).

Subsequently, the restoration unit 140 performs the restoration processing on the divided prefix token, to restore the size thereof (step S202). Especially in the present example embodiment, the modification unit 140 performs the in-block modification processing on one of the patch tokens (step S601). This processing may be the same processing as the in-block modification processing in the fifth example embodiment (i.e., the step S501 in FIG. 14). Thereafter, the arithmetic unit 130 performs the tensor transformation/integration on the restored prefix token and the patch token on which the in-block modification processing is performed. (step S203).

### Technical Effect

Next, a technical effect obtained by the information processing apparatus 10 according to the sixth example embodiment will be described.

As described in FIG. 17, in the information processing apparatus 10 according to the sixth example embodiment, in the feature transformation processing, the patch token is modified to provide a 1×1 convolutional layer (fully coupled layer) in the area of the block. In this way, it is possible to eliminate the lack of information about the local area caused by the division using the grid pattern. Therefore, for example, it is possible to suppress/prevent a reduction in processing accuracy caused by the lack of information about the local area.

The fifth and sixth example embodiments may be realized in combination. That is, the in-block modification processing may be performed on both the query, the key, and the value, and the result of the arithmetic operation of self-attention mechanism.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes a processing alone, but also the program that operates on an OS and that executes a processing in cooperation with the functions of expansion boards and another software, is also included in the scope of each of the example embodiments. In addition, the program itself may be stored in a server, and a part or all of the program may be downloaded from the server to a user terminal.

### SUPPLEMENTARY NOTES

The example embodiments described above may be further described as, but not limited to, the following Supplementary Notes below.

### Supplementary Note 1

An information processing apparatus according to Supplementary Note 1 is an information processing apparatus including: a generation unit that generates a patch token and a prefix token corresponding to an input image; an extension unit that extends the prefix token to a prefix token block having a size corresponding to a number of a plurality of patch token blocks into which the patch token is segmented in accordance with a predetermined grid pattern; and an arithmetic unit that performs an arithmetic operation on the prefix token block and the patch token blocks, on the basis of a self-attention mechanism, for each group of elements located at a common position in the respective blocks.

### Supplementary Note 2

An information processing apparatus according to Supplementary Note 2 is the information processing apparatus according to Supplementary Note 1, further including a restoration unit that restores a size of a feature quantity corresponding to the prefix token block, of feature quantities obtained as a result of the arithmetic operation of the arithmetic unit, to a size of the prefix token before extension.

### Supplementary Note 3

An information processing apparatus according to Supplementary Note 3 is the information processing apparatus according to Supplementary Note 2, wherein the restoration unit restores the size of the feature quantity corresponding to the prefix token block, to the size of the prefix token before extension, by calculating a mean value of elements included in the feature quantity.

### Supplementary Note 4

An information processing apparatus according to Supplementary Note 4 is the information processing apparatus according to Supplementary Note 2, wherein the restoration unit restores the size of the feature quantity corresponding to the prefix token block, to the size of the prefix token before extension, by calculating a maximum value of elements included in the feature quantity.

### Supplementary Note 5

An information processing apparatus according to Supplementary Note 5 is the information processing apparatus according to any one of Supplementary Notes 1 to 4, further including a modification unit that modifies the patch token to a tensor that provides a 1×1 convolutional layer in each block.

### Supplementary Note 6

An information processing apparatus according to Supplementary Note 6 is the information processing apparatus according to Supplementary Note 5, wherein the modification unit modifies a tensor, for at least one of a query, a key, and a value in the self-attention mechanism and a feature quantity obtained as a result of the arithmetic operation of the self-attention mechanism.

### Supplementary Note 7

An information processing method according to Supplementary Note 7 is an information processing method that is executed by at least one computer, the information processing method including: generating a patch token and a prefix token corresponding to an input image; extending the prefix token to a prefix token block having a size corresponding to a number of a plurality of patch token blocks into which the patch token is segmented in accordance with a predetermined grid pattern; and performing an arithmetic operation on the prefix token block and the patch token blocks, on the basis of a self-attention mechanism, for each group of elements located at a common position in the respective blocks.

### Supplementary Note 8

A recording medium according to Supplementary Note 8 is a recording medium on which a computer program that allows at least one computer to execute an information processing method is recorded, the information processing method including: generating a patch token and a prefix token corresponding to an input image; extending the prefix token to a prefix token block having a size corresponding to a number of a plurality of patch token blocks into which the patch token is segmented in accordance with a predetermined grid pattern; and performing an arithmetic operation on the prefix token block and the patch token blocks, on the basis of a self-attention mechanism, for each group of elements located at a common position in the respective blocks.

### Supplementary Note 9

A computer program according to Supplementary Note 9 is a computer program that allows at least one computer to execute an information processing method, the information processing method including: generating a patch token and a prefix token corresponding to an input image; extending the prefix token to a prefix token block having a size corresponding to a number of a plurality of patch token blocks into which the patch token is segmented in accordance with a predetermined grid pattern; and performing an arithmetic operation on the prefix token block and the patch token blocks, on the basis of a self-attention mechanism, for each group of elements located at a common position in the respective blocks.

This disclosure is allowed to be changed, if desired, without departing from the essence or spirit of this disclosure which can be read from the claims and the entire specification. An information processing apparatus, an information processing method, a recording medium, and a data structure with such changes are also intended to be within the technical scope of this disclosure.

### DESCRIPTION OF REFERENCE CODES

10 Information processing apparatus
11 Processor
20 Self-attention mechanism unit
30 Feature transformation unit
31 Feature embedding processing unit (Query)
32 Feature embedding processing unit (Key)
33 Feature embedding processing unit (Value)
34 Correlation calculation unit
35 Summarization processing unit
36 Residual processing unit
37 Feature transformation processing unit
50 Transformation block
55 Batch embedding processing unit
110 Generation unit
120 Extension unit
130 Arithmetic unit
140 Restoration unit
150, 155 Modification unit

What is claimed is:

1. An information processing apparatus comprising:
at least one memory that is configured to store instructions; and
at least one processor that is configured to execute the instructions to:
generate a patch token and a prefix token corresponding to an input image;
extend the prefix token to a prefix token block having a size corresponding to a number of a plurality of patch token blocks into which the patch token is segmented in accordance with a predetermined grid pattern; and
perform an arithmetic operation on the prefix token block and the patch token blocks, on the basis of a self-attention mechanism, for each group of elements located at a common position in the respective blocks.

2. The information processing apparatus according to claim 1, wherein the at least one processor is configured to execute the instructions to restore a size of a feature quantity corresponding to the prefix token block, of feature quantities obtained as a result of the arithmetic operation, to a size of the prefix token before extension.

3. The information processing apparatus according to claim 2, wherein the at least one processor is configured to execute the instructions to restore the size of the feature quantity corresponding to the prefix token block, to the size of the prefix token before extension, by calculating a mean value of elements included in the feature quantity.

4. The information processing apparatus according to claim 2, wherein the at least one processor is configured to execute the instructions to restore the size of the feature quantity corresponding to the prefix token block, to the size of the prefix token before extension, by calculating a maximum value of elements included in the feature quantity.

5. The information processing apparatus according to claim 1, wherein the at least one processor is configured to execute the instructions to modify the patch token to a tensor that provides a 1×1 convolutional layer in each block.

6. The information processing apparatus according to claim 5, wherein the at least one processor is configured to execute the instructions to modify a tensor, for at least one of a query, a key, and a value in the self-attention mechanism and a feature quantity obtained as a result of the arithmetic operation of the self-attention mechanism.

7. An information processing method that is executed by at least one computer, the information processing method comprising:
generating a patch token and a prefix token corresponding to an input image;
extending the prefix token to a prefix token block having a size corresponding to a number of a plurality of patch token blocks into which the patch token is segmented in accordance with a predetermined grid pattern; and
performing an arithmetic operation on the prefix token block and the patch token blocks, on the basis of a self-attention mechanism, for each group of elements located at a common position in the respective blocks.

8. A non-transitory recording medium on which a computer program that allows at least one computer to execute an information processing method is recorded, the information processing method including:
generating a patch token and a prefix token corresponding to an input image;
extending the prefix token to a prefix token block having a size corresponding to a number of a plurality of patch token blocks into which the patch token is segmented in accordance with a predetermined grid pattern; and
performing an arithmetic operation on the prefix token block and the patch token blocks, on the basis of a self-attention mechanism, for each group of elements located at a common position in the respective blocks.
